(19) United States
(12) Patent Application Publication
(10) Pub. No.: US 2024/0378551 A1
(43) Pub. Date: Nov. 14, 2024

(54) INFORMATION PROCESSING APPARATUS, INFORMATION PROCESSING METHOD, AND NON-TRANSITORY STORAGE MEDIUM

(71) Applicant: NEC Corporation, Minato-ku, Tokyo (JP)

(72) Inventors: Shintarou Ushio, Tokyo (JP); Junichiro Uehara, Tokyo (JP); Kohei Suga, Tokyo (JP); Daisuke Kawasaki, Tokyo (JP); Kaori Yamane, Tokyo (JP)

(73) Assignee: NEC Corporation, Minato-ku, Tokyo (JP)

(21) Appl. No.: 18/287,367

(22) PCT Filed: Apr. 30, 2021
(86) PCT No.: PCT/JP2021/017222

§ 371 Date: Oct. 18, 2023

(51) Int. Cl. G06Q 10/087; G06V 30/148

(52) U.S. Cl. CPC G06Q 10/087; G06V 30/153

(57) ABSTRACT

The present invention provides an information processing apparatus (10) including an acquisition unit (11) that acquires invoice information including a plurality of pieces of purchase data including at least cargo identification information and quantity information, and packing list information including a plurality of pieces of packing data including at least the cargo identification information and the quantity information, and a generation unit (12) that determines a correlation between the purchase data included in the invoice information and the packing data included in the packing list information by using a combination of the cargo identification information and the quantity information, and generates output information with which the purchase data and the packing data that are associated with each other are associated.

### TECHNICAL FIELD

The present invention relates to an information processing apparatus, an information processing method, and a program.

### BACKGROUND ART

In a customs clearance operation, it is necessary to generate various documents including various pieces of information. This process is time-consuming when it is done manually. Patent Document 1 discloses a document management apparatus that generates invoice data, based on order request data, and generates a packing list, based on the invoice data.

### RELATED DOCUMENT

### Patent Document

Patent Document 1: Japanese Patent Application Publication No. 2004-295436

### DISCLOSURE OF THE INVENTION

### Technical Problem

In a customs clearance operation, it is necessary to generate a document such as an export/import declaration with reference to a plurality of types of documents. For example, during document generation, a description, a quantity, a price, and the like of each cargo described in an invoice are referred to, and a weight and the like of each cargo described in a packing list are also referred to. In such a case, it is time-consuming to determine a correlation of information relating to the same cargo described across a plurality of types of documents. An object of the present invention is to improve work efficiency in a customs clearance operation.

### Solution to Problem

According to the present invention, there is provided an information processing apparatus, including:
an acquisition unit that acquires invoice information including a plurality of pieces of purchase data including at least cargo identification information and quantity information, and packing list information including a plurality of pieces of packing data including at least the cargo identification information and the quantity information; and
a generation unit that determines a correlation between the purchase data included in the invoice information and the packing data included in the packing list information by using a combination of the cargo identification information and the quantity information, and generates output information with which the purchase data and the packing data that are associated with each other are associated.

Further, according to the present invention, there is provided an information processing method including,
by a computer to execute:
an acquisition step of acquiring invoice information including a plurality of pieces of purchase data including at least cargo identification information and quantity information, and packing list information including a plurality of pieces of packing data including at least the cargo identification information and the quantity information; and
a generation step of determining a correlation between the purchase data included in the invoice information and the packing data included in the packing list information by using a combination of the cargo identification information and the quantity information, and generating output information with which the purchase data and the packing data that are associated with each other are associated.

Further, according to the present invention, there is provided a program causing a computer to function as:
an acquisition unit that acquires invoice information including a plurality of pieces of purchase data including at least cargo identification information and quantity information, and packing list information including a plurality of pieces of packing data including at least the cargo identification information and the quantity information; and
a generation unit that determines a correlation between the purchase data included in the invoice information and the packing data included in the packing list information by using a combination of the cargo identification information and the quantity information, and generates output information with which the purchase data and the packing data that are associated with each other are associated.

### Advantageous Effects of Invention

According to the present invention, work efficiency in a customs clearance operation is improved.

### BRIEF DESCRIPTION OF THE DRAWINGS

FIG. 1 It is a diagram illustrating one example of an invoice of the present example embodiment.

FIG. 2 It is a diagram illustrating one example of invoice information of the present example embodiment.

FIG. 3 It is a diagram illustrating one example of a packing list of the present example embodiment.

FIG. 4 It is a diagram illustrating one example of packing list information of the present example embodiment.

FIG. 5 It is one example of a function block diagram of an information processing apparatus of the present example embodiment.

FIG. 6 It is one example of a function block diagram of the information processing apparatus of the present example embodiment.

FIG. 7 It is a diagram illustrating one example of output information of the present example embodiment.

FIG. 8 It is a flowchart illustrating one example of a flow of processing of the information processing apparatus of the present example embodiment.

FIG. 9 It is a flowchart illustrating one example of a flow of processing of the information processing apparatus of the present example embodiment.

FIG. 10 It is a diagram illustrating one example of a hardware configuration of the information processing apparatus of the present example embodiment.

FIG. 11 It is a diagram for describing an example in which the information processing apparatus of the present example embodiment is used.

### DESCRIPTION OF EMBODIMENTS

An example embodiment of the present invention is described below with reference to the drawings. Note that, in all the drawings, a similar constituent element is denoted with a similar reference sign, and description therefor is omitted as appropriate.

### Overview

An information processing apparatus of the present example embodiment includes a function of determining a correlation between purchase data included in invoice information and packing data included in packing list information by using a combination of cargo identification information and quantity information and generating output information with which the purchase data and the packing data that are associated with each other are associated. According to such an information processing apparatus of the present example embodiment, a user can easily determine the correlation between the purchase data and the packing data with reference to the output information, and thus a time-consuming work for determining the correlation by viewing a document repeatedly by one's self can be avoided.

### Description for Terms

Herein, main terms are described.

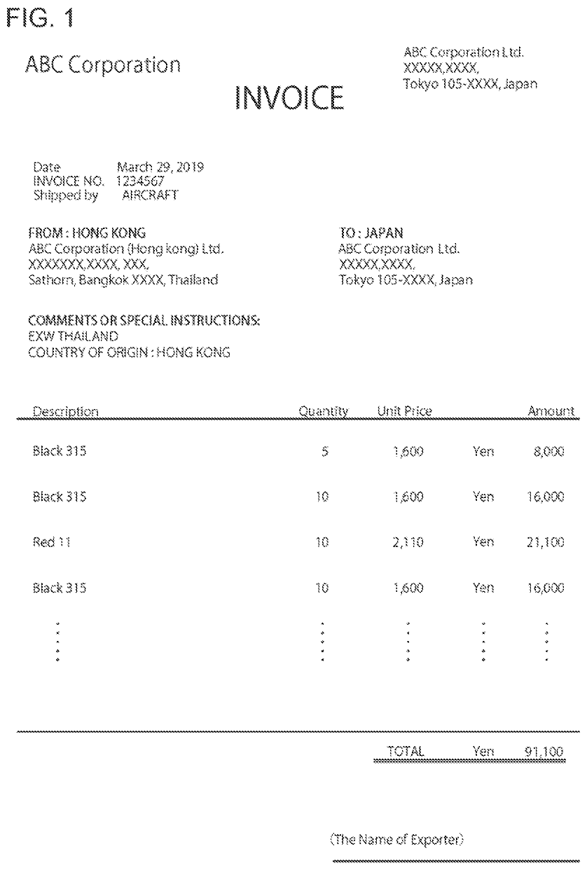

An “invoice” is a document that is generated by an exporter and includes various types of information relating to a transaction. For example, a description, a quantity, a price, and the like of a cargo are described in the invoice. The invoice is referred to as an invoice, a shipping document, and the like in some cases. FIG. 1 illustrates one example of the invoice. In the invoice illustrated herein, a description of a cargo (Description), a quantity of cargos (Quantity), a unit price of a cargo (Unit Price), an amount being a product of the quantity and the unit price (Amount) are illustrated.

In the invoice illustrated herein, three or more items with the same description “Black 315” are described individually. In the invoice, information is described for each of any description units such as an order unit and a delivery location unit, and thus items with the same description are described individually in some cases.

Further, as illustrated in the drawing, the invoice includes an invoice No. for identifying a plurality of invoices from each other, exporter information, importer information, and the like.

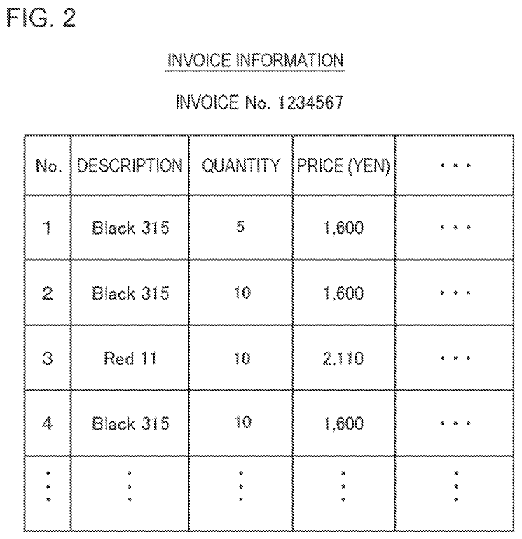

“Invoice information” is electronic data including information described in the invoice. FIG. 2 schematically illustrates one example of the invoice information. The invoice information in FIG. 2 includes the information described in the invoice illustrated in FIG. 1. As illustrated in FIG. 2, the invoice information is information in which description information, quantity information, price information, and the like are associated with each other for each description unit being described in the invoice. Note that, in the example illustrated in FIG. 2, the invoice information does not include weight information. Further, in the example illustrated in FIG. 2, one “No.” is provided to one description unit. Hereinafter, data for one description unit are referred to as “purchase data”. A piece of data associated with “No. 1” illustrated in FIG. 2 is one piece of purchase data. The piece of purchase data associated with “No. 1” and a piece of purchase data associated with “No. 2” that are illustrated in FIG. 2 are different pieces of purchase data from each other.

Further, as illustrated in the drawing, the invoice information includes an invoice No. Although not illustrated, the invoice information may include exporter information, importer information, and the like.

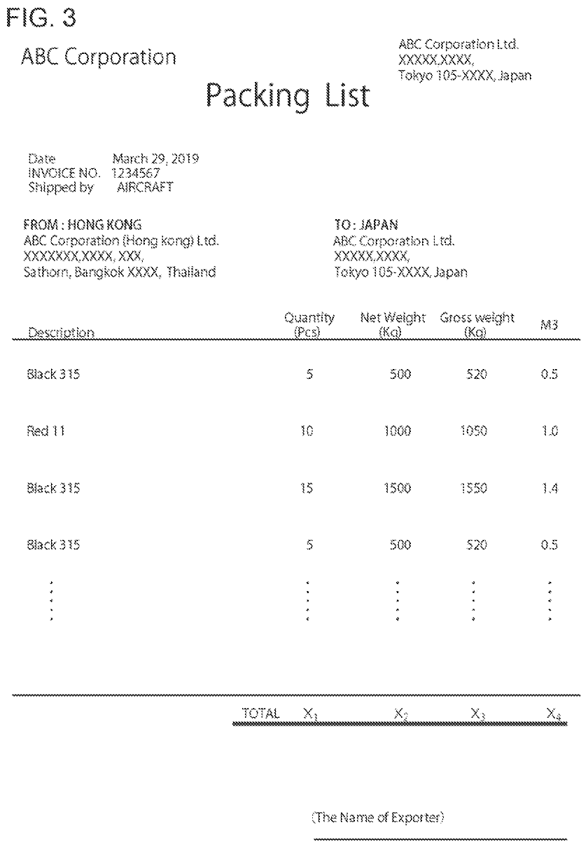

A “packing list” is a document that complements an invoice, and is generated for each invoice. In other words, complementary information relating to a cargo described in a certain invoice is described in an associated packing list. For example, a description, a quantity, a weight (a net weight or a gross weight), a volume, and the like of a cargo are described in the packing list. Information not being described in the invoice, for example, a weight, a volume, and the like are included in the packing list. The packing list may be referred to as a packing list, a package manifest, and the like. FIG. 3 illustrates one example of the packing list. In the packing list illustrated herein, a description of a cargo (Description), a quantity of cargos (Quantity), a net weight of a cargo (Net Weight), a gross weight of a cargo (Gross Weight), and a volume (M3) are illustrated.

In the packing list illustrated herein, three or more items with the same description “Black 315” are described individually. In the packing list, information is described for each of any description units such as a packing unit, and thus items with the same description are described individually in some cases. Note that, as apparent from comparison between FIG. 1 and FIG. 3, the description unit in the invoice and the description unit in the packing list do not necessarily match with each other.

Further, as illustrated in the drawing, the packing list includes an invoice No., exporter information, importer information, and the like. An invoice associated therewith can be determined by using the invoice No.

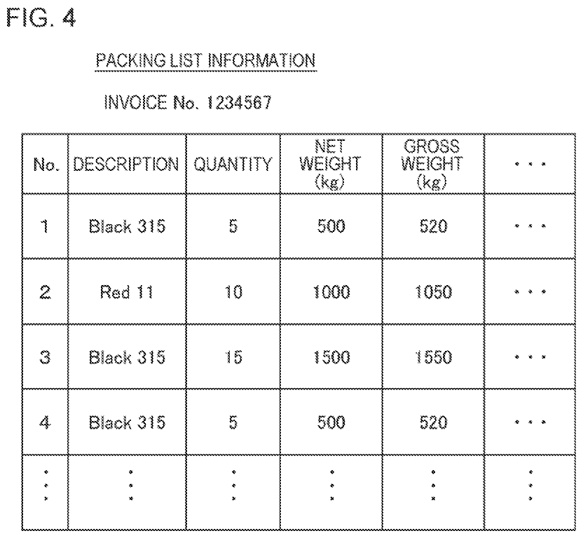

“Packing list information” is electronic data including information described in the packing list. FIG. 4 schematically illustrates one example of the packing list information. The packing list information in FIG. 4 includes the information described in the packing list illustrated in FIG. 3. As illustrated in FIG. 4, the packing list information is information in which description information, quantity information, weight information (at least one of net weight information and gross weight information), and the like are associated with each other for each description unit being described in the packing list. In the example illustrated in FIG. 4, one “No.” is provided to one description unit. Hereinafter, data for one description unit are referred to as “packing data”. A piece of data associated with “No. 1” illustrated in FIG. 4 is one piece of packing data. The piece of packing data associated with “No. 1” and a piece of packing data associated with “No. 2” that are illustrated in FIG. 4 are different pieces of packing data from each other.

Further, as illustrated in the drawing, the packing list information includes an invoice No. Although not illustrated, the packing list information may include exporter information, importer information, and the like.

Note that, as described above, a packing list is generated in association with an invoice. Further, information relating to a cargo described in a certain invoice is described in an associated packing list. This correlation is also maintained between packing list information and invoice information. In other words, information relating to a cargo described in certain invoice information is described in associated packing list information. However, as described above, the description unit in the invoice and the description unit in the packing list do not necessarily match with each other. Thus, a plurality of pieces of purchase data illustrated in FIG. 2 and a plurality of pieces of packing data illustrated in FIG. 4 do not necessarily establish one-on-one correlations. This causes work for determining a correlation between the information described in the invoice and the information described in the packing list to complicate.

### Function Configuration

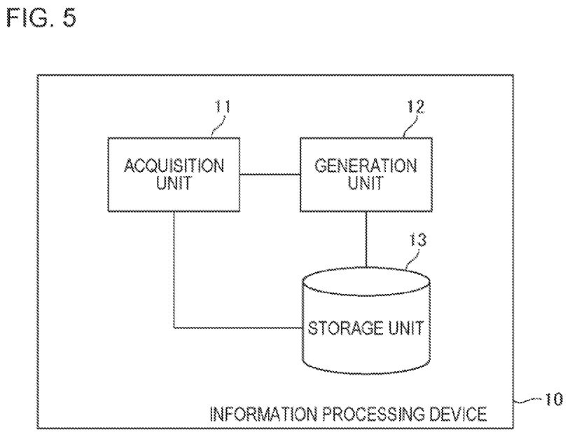

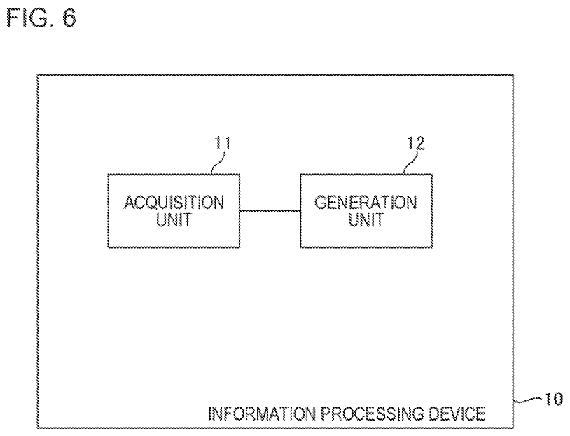

Next, a function configuration of an information processing apparatus 10 is described. In FIG. 5, one example of a function block diagram of the information processing apparatus 10 is described. As illustrated in the drawing, the information processing apparatus 10 includes an acquisition unit 11, a generation unit 12, and a storage unit 13. Note that, as illustrated in a function block diagram in FIG. 6, the information processing apparatus 10 is not required to include the storage unit 13. In such a case, an external apparatus configured to be communicable with the information processing apparatus 10 includes the storage unit 13.

The acquisition unit 11 acquires invoice information and packing list information. Details of the invoice information and the packing list information are as described above. The invoice information includes at least cargo identification information and quantity information. Similarly, the packing list information includes at least the cargo identification information and the quantity information. The cargo identification information is information for identifying a cargo, and examples thereof include a description, a product name, product identification information, and the like. Examples of the product identification information may include a description item No. and the like for identifying a description item of a product, but are not limited thereto. In the example illustrated in FIGS. 2 and 4, a description is the cargo identification information.

For example, the acquisition unit 11 may include a character recognition function such as an optical character recognition function. Further, the acquisition unit 11 may read various information from an invoice as illustrated in FIG. 1 or a packing list as illustrated in FIG. 3 by using the function, and generate or acquire invoice information as illustrated in FIG. 2 or packing list information as illustrated in FIG. 4.

In addition, the acquisition unit 11 may provide a user with a user interface (UI) screen, and also receive an input of various information included in the invoice and the packing list via the UI screen. Further, the acquisition unit 11 may generate or acquire invoice information as illustrated in FIG. 2 or packing list information as illustrated in FIG. 4, based on the input information. Provision of the UI screen is achieved via various output apparatuses such as a display and a projection apparatus. Reception of an input of various information is achieved via various input apparatuses such as a touch panel, a keyboard, a mouse, a physical button, and a microphone.

In addition, invoice information as illustrated in FIG. 2 or packing list information as illustrated in FIG. 4 may be stored in advance in the storage unit 13 or an external apparatus. Further, the acquisition unit 11 may achieve acquisition of the invoice information and the packing list information by reading out information being stored in the storage unit 13 or receiving an input from the external apparatus.

The generation unit 12 executes “processing of determining invoice information and packing list information that are associated with each other”, “processing of determining purchase data and packing data that are associated with each other”, and “processing of generating output information” in the stated order. Details of each pieces of processing is described below.

Processing of Determining Invoice Information and Packing List Information that are Associated with Each Other

The generation unit 12 processes the invoice information and the packing list information that are acquired by the acquisition unit 11, and determines the invoice information and the packing list information that are associated with each other. For example, the generation unit 12 determines a piece of invoice information and a piece of packing list information that have a matching invoice No., as the invoice information and the packing list information that are associated with each other. Note that, information other than the invoice No. may be used.

Processing of Determining Purchase Data and Packing Data that are Associated with Each Other

After the processing of determining the invoice information and the packing list information that are associated with each other is executed, the generation unit 12 executes subsequent processing for a combination of the invoice information and the packing list information that are associated with each other. First, the generation unit 12 determines a correlation between the purchase data included in the invoice information and the packing data included in the packing list information by using the combination of the cargo identification information and the quantity information. Specifically, the generation unit 12 determines the correlation by following a rule given below:

(Rule) A piece of purchase data and a piece of packing data including the matching combination of the cargo identification information and the quantity information are determined as the pieces of data that are associated with each other.

Description is made on the example illustrated in FIGS. 2 and 4. In the example in FIGS. 2 and 4, the piece of purchase data of No. 1 in the invoice information and the piece of packing data of No. 1 in the packing list information include the matching combination of the cargo identification information (in the drawings, the description) and the quantity information. Thus, the generation unit 12 determines the piece of purchase data of No. 1 and the piece of packing data of No. 1, as the pieces of data that are associated with each other. Further, a piece of purchase data of No. 3 in the invoice information and a piece of packing data of No. 2 in the packing list information include the matching combination of the cargo identification information and the quantity information. Thus, the generation unit 12 determines the piece of purchase data of No. 3 and the piece of packing data of No. 2 as the pieces of data that are associated with each other.

Note that, when there is a piece of non-matching packing data being a piece of packing data in which the combination of the cargo identification information and the quantity information does not match with any piece of the purchase data, the generation unit 12 generates collective data acquired by collecting the pieces of non-matching packing data. The generation unit 12 is capable of generating the collective data for each set of the pieces of non-matching packing data including the cargo identification information being identical.

In the example in FIGS. 2 and 4, for pieces of packing data of No. 3 and No. 4 in the packing list information, the purchase data including the matching combination of the cargo identification information (in the drawings, the description) and the quantity information does not exist. Thus, the pieces of packing data of No. 3 and No. 4 become the pieces of non-matching packing data. Further, the cargo identification information included in each of the pieces of packing data of No. 3 and No. 4 is Black315. Thus, the pieces of packing data of No. 3 and No. 4 constitute a set of the pieces of non-matching packing data including the cargo identification information being identical.

The generation unit 12 computes a total value of weights as the collective data for each set of the pieces of non-matching packing data including the cargo identification information being identical. In the example in FIGS. 2 and 4, when only the pieces of packing data of No. 3 and No. 4 are the pieces of non-matching packing data including Black315 as the cargo identification information, at least one of 2,000 kg being a total value of net weights and 2,070 kg being a total value of gross weights is computed as the collective data of the set.

### Processing of Generating Output Information

After the processing of determining the purchase data and the packing data that are associated with each other is executed, the generation unit 12 generates output information with which the purchase data and the packing data that are associated with each other are associated.

Note that, when there is the non-matching packing data, the generation unit 12 associates, in the above-mentioned output information, the collective data being the total value of the weights, which is described above, with any of the pieces of non-matching purchase data being the purchase data in which the combination of the cargo identification information and the quantity information does not match with any piece of the packing data. When the collective data is generated for each set of the pieces of non-matching packing data including the cargo identification information being identical, the generation unit 12 associates, in the above-mentioned output information, the collective data for each set with any of the pieces of non-matching purchase data including the cargo identification information being identical to the cargo identification information in each set. Further, the generation unit 12 associates another piece of non-matching purchase data with weight information “0”.

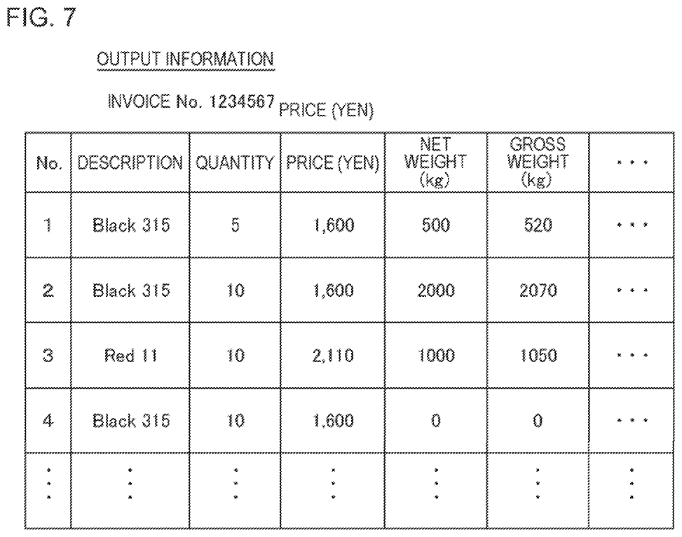

Description is made on the example illustrated in FIGS. 2 and 4. In the example in FIGS. 2 and 4, output information as illustrated, for example, in FIG. 7 is generated. In the output information illustrated in FIG. 7, a plurality of pieces of data (hereinafter, referred to as output information data) that are identified from each other with No. are illustrated. In the illustrated example, the output information data are data in which a description being cargo identification information, quantity information, price information, and weight information are associated with one another. The cargo identification information and the quantity information are information included in both the invoice information and the packing list information. The price information is information included in the invoice information. The weight information is information included in the packing list information. Note that, items illustrated in the drawing are merely examples, and other information included in at least one of the invoice information and the packing list information may be included in the output information.

Incidentally, the plurality of pieces of output information data included in the output information illustrated in FIG. 7 and the plurality of pieces of purchase data included in the invoice information illustrated in FIG. 2 are associated with each other in a one-on-one manner. Further, an order of the plurality of pieces of output information data is associated with an order of the plurality of pieces of purchase data. In other words, a piece of output information data of No. 1 is associated with the piece of purchase data of No. 1, and a piece of output information data of No. 2 is associated with the piece of purchase data of No. 2. In such a case, the output information can be regarded as information acquired by adding the information extracted from the packing list information in FIG. 4, specifically, the weight information, to the invoice information in FIG. 2.

As described above, the piece of purchase data of No. 1 in the invoice information and the piece of packing data of No. 1 in the packing list information are associated with each other. The piece of output information data of No. 1 in the output information is a piece of data in which the piece of purchase data of No. 1 in the invoice information and the packing data of No. 1 in the packing list information are associated with each other. The piece of output information data of No. 1 in the output information can also be regarded as a piece of data acquired by adding at least one item of the data (the weight information) being the piece of packing data of No. 1 in the packing list information to the piece of purchase data of No. 1 in the invoice information.

Further, as described above, the piece of purchase data of No. 3 in the invoice information and the piece of packing data of No. 2 in the packing list information are associated with each other. A piece of output information data of No. 3 in the output information is a piece of data in which the piece of purchase data of No. 3 in the invoice information and the piece of packing data of No. 2 in the packing list information are associated with each other. The piece of output information data of No. 3 in the output information can also be regarded as a piece of data acquiring by adding at least one item of the data (the weight information) being the piece of packing data of No. 2 in the packing list information to the piece of purchase data of No. 3 in the invoice information.

The piece of output information data of No. 2 in the output information is associated with the piece of purchase data of No. 2 in the invoice information. Further, a piece of output information data of No. 4 in the output information is associated with a piece of purchase data of No. 4 in the invoice information. Further, the piece of purchase data of No. 2 and the piece of purchase data of No. 4 in the invoice information are the non-matching purchase data (the purchase data with which no packing data is associated) including Black315 being the cargo identification information being identical. Thus, as illustrated in FIG. 7, the generation unit 12 adds, to the piece of output information data of No. 2, the total value of the weights (the collective data) of the pieces of non-matching packing data including Black315 being the cargo identification information being identical. Further, the generation unit 12 adds “0” as the weight information to the piece of output information data of No. 4.

Note that, when the collective data is to be added to any of a plurality of pieces of non-matching purchase data, various variations are conceivable. In the illustrated example, the total value of the weights is added to a piece of non-matching purchase data at the topmost position in an order, but the total value of the weights may be alternatively added to another piece of non-matching purchase data.

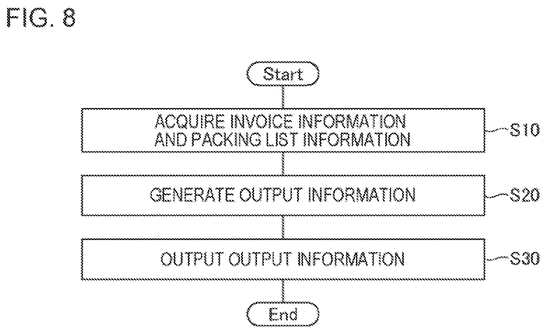

Next, with reference to a flowchart in FIG. 8, one example of a flow of processing of the information processing apparatus 10 is described.

First, the information processing apparatus 10 acquires invoice information and packing list information (S10). Subsequently, the information processing apparatus 10 generates output information, based on the invoice information and the packing list information that are acquired (S20). Further, the information processing apparatus 10 outputs the output information being generated (S30). For example, the information processing apparatus 10 generates the output information as illustrated in FIG. 7, based on the invoice information as illustrated in FIG. 2 and the packing list information illustrated in FIG. 4, and outputs the generated output information. Output of the output information is achieved via various output apparatuses such as a display, a projection apparatus, and an electronic mail client.

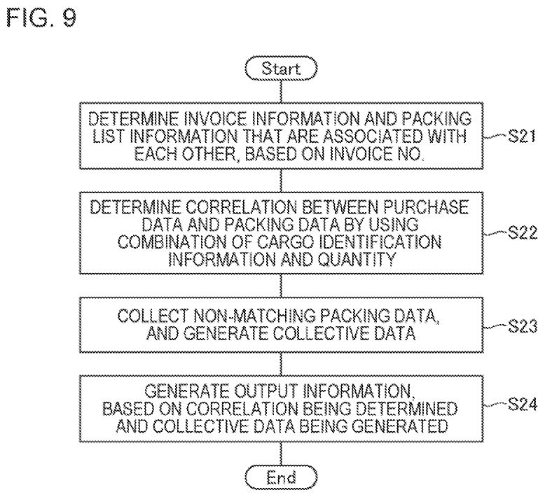

Next, with reference to a flowchart in FIG. 9, one example of a flow of the processing in S20 is described.

First, the information processing apparatus 10 determines invoice information and packing list information that are associated with each other, based on an invoice No. (S21). Subsequently, the information processing apparatus 10 subjects the invoice information and the packing list information that are associated with each other to processing in S22 to S24.

In S22, the information processing apparatus 10 determines a correlation between the purchase data and the packing data by using a combination of cargo identification information and a quantity. In S23, the information processing apparatus 10 executes processing of collecting non-matching packing data and generating collective data. Note that, when the non-matching packing data are not present, S23 can be omitted.

In S24, the information processing apparatus 10 generates output information, based on the correlation being determined in S22 and the collective data that are generated in S23.

### Hardware Configuration

Next, one example of a hardware configuration of the information processing apparatus 10 is described. Each of function units of the information processing apparatus 10 is achieved by any combination of hardware and software, mainly including a central processing unit (CPU) of any computer, a memory, a program loaded in a memory, a storage unit such as a hard disk for storing the program (capable of storing a program downloaded from a storage medium such as a compact disc (CD), a server on the Internet, or the like, in addition to a program stored in advance at a stage of shipment), and an interface for network connection. Further, it is understood by a person skilled in the art that various modification examples are conceivable for methods and apparatuses for the achievement.

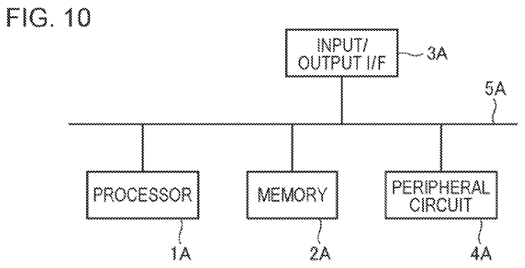

FIG. 10 is a block diagram illustrating the hardware configuration of the information processing apparatus 10. As illustrated in FIG. 10, the information processing apparatus 10 includes a processor 1A, a memory 2A, an input/output interface 3A, a peripheral circuit 4A, and a bus 5A. The peripheral circuit 4A includes various modules. The information processing apparatus 10 is not required to include the peripheral circuit 4A. Note that, the information processing apparatus 10 may be configured by a plurality of apparatuses that are separated from each other physically and/or logically. In such a case, each of the plurality of apparatuses may include the hardware configuration described above.

The bus 5A is a data transmission path in which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. Examples of the input apparatus include a keyboard, a mouse, a microphone, a physical button, a touch panel, and the like. Examples of the output apparatus include a display, a speaker, a printer, a mailer, and the like. The processor IA is capable of issuing a command to each module and executing an arithmetic operation, based on an arithmetic result therefrom.

### Advantageous Effects

The information processing apparatus 10 of the present example embodiment is capable of determining a correlation between invoice information and packing list information, also determining the correlation between purchase data and packing data, and generating output information with which the purchase data and the packing data that are associated with each other are associated. According to the information processing apparatus 10 of the present example embodiment described above, a user can easily determine the correlation between the purchase data and the packing data with reference to the output information, and thus time-consuming work for determining the correlation by viewing a document repeatedly by one's self can be avoided.

Further, when there is non-matching packing data with which no purchase data is associated, the information processing apparatus 10 of the present example embodiment is capable of generating collective data being a total value of weight information in the non-matching packing data, and associating the generated collective data with the non-matching purchase data with which no packing data is associated. A weight of each of a plurality of pieces of purchase data is not required for a customs clearance operation, and it is only required to grasp a gross weight of each cargo. Thus, even when there is the non-matching purchase data, the information processing apparatus 10 of the present example embodiment associates the total value of the weight information in the non-matching packing data with any of pieces of the non-matching purchase data, and also associates other pieces of non-matching purchase data with the weight information “0”, instead of executing time-consuming arithmetic processing of computing a weight of each piece of the non-matching purchase data. With this association, a user can easily recognize the gross weight of each cargo, and thus a customs clearance operation can smoothly be performed. Further, the arithmetic processing of computing a weight of each piece of the non-matching purchase data can be avoided, and thus the information processing apparatus 10 can alleviate a processing load on a computer.

### MODIFICATION EXAMPLES

### First Modification Example

When the acquisition unit 11 acquires at least one of invoice information and packing list information by using the character recognition function, the acquisition unit 11 may acquire a plurality of types of cargo identification information. The plurality of types of cargo identification information includes information in a form of characters such as a description and information in a form of numerals such as a description item No. Further, the acquisition unit 11 reads the description item No. with the character recognition function, and then reads out a description associated with the description item No. being read, with reference to a description item master being stored in advance in the storage unit 13. Further, the acquisition unit 11 may display a description being read from the invoice information or the packing list information with the character recognition function and a description being read out from the description item master in a side-by-side manner, and also receive a user input for correcting a content. In such a case, the acquisition unit 11 may display a piece of data (the purchase data or the packing list data) in which the description being read from the invoice information or the packing list information with the character recognition function and the description being read out from the description item master do not match with each other in an identifiable manner.

### Second Modification Example

In the invoice, predetermined information for identifying a plurality of invoices, for example, page information may be described. Further, when the acquisition unit 11 acquires the invoice information by using the character recognition function, the acquisition unit 11 may further read the page information to be included in the invoice information. In this manner, predetermined invoice information can be tracked by using the page information. For example, it is possible to track a page of the invoice on which certain purchase data are described. Further, for the packing list, it may be possible to read out page information as well and track by using the page information.

### Third Modification Example

In the example embodiment described above, the collective data being the total value of the weights is associated with one piece of the non-matching purchase data, and the weight information “0” is associated with other pieces of non-matching purchase data, but the example embodiment is not limited thereto. For example, the generation unit 12 may divide (into equal parts, for example) the collective data being the total value of the weights, and associate a divided part with each piece of the non-matching purchase data.

### Forth Modification Example

The generation unit 12 may add, to the piece of non-matching purchase data, flag information indicating the piece of non-matching purchase data at a time of generating the output information data, and may display the piece of non-matching purchase data and other pieces of purchase data in different modes (for example, in different colors or with different character types) at a time of display.

### EXAMPLE

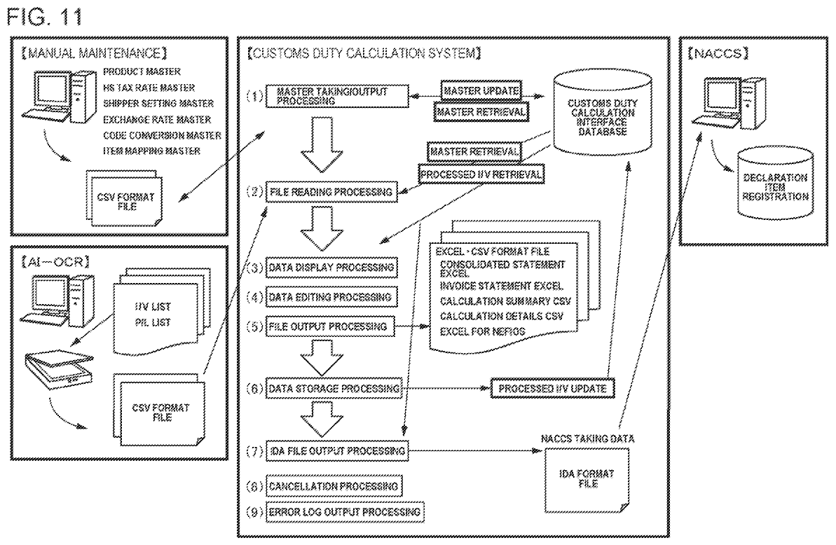

With reference to FIG. 11, description is made on an example in which the information acquisition apparatus 10 of the present example embodiment is used.

A block “manual maintenance” in the drawing is a block in which various types of data are generated or corrected according to a user input. This is achieved via a terminal apparatus such as a personal computer and a tablet terminal. Data being a processing target are a product master, an HS tax rate master, a shipper setting master, an exchange rate master, a code conversion master, an item mapping master, or the like.

A block “AI-OCR” in the drawing is a block in which electronic data are generated by using the character recognition function. For example, the invoice information is generated from the invoice, and the packing list information is generated from the packing list.

A block “customs duty calculation system” in the drawing is a block in which data required for a customs clearance operation are generated based on the data generated in the block “manual maintenance” or the block “AI-OCR”.

(1) Master taking/output processing is processing in which data stored in a customs duty calculation interface database are read out and output via a terminal apparatus such as a personal computer and a tablet terminal (master retrieval), and data stored in the customs duty calculation interface database are updated based on an input via the terminal apparatus (master update).

(2) File reading processing is processing in which a CSV file generated by optical character recognition (OCR) is took in the customs duty calculation system by specifying a path being a storage destination of the CSV file. Reading of the CSV file can be specified for each of the invoice information and the packing list information.

(3) Data display processing is processing in which contents of the CSV file taken by the file reading processing are set and displayed in screen items set for each field of the CSV file. Display position setting for screen display items is set in a shipper master.

(4) Data editing processing is processing in which input or correction is performed for the content in each item displayed by the data display processing or a blank item not being set.

(5) File output processing is processing in which the invoice information and the packing list information that are edited by the data editing processing are converted into a file format for predetermined spreadsheet software, and output.

(6) Data storage processing is processing in which the invoice information and the packing list information that are edited by the data editing processing are written in a database of the customs duty calculation system.

(7) IDA file output processing is processing in which customs duty calculation result information totalized by the customs duty calculation system is arranged in an array of items that can be read by a NACCS system and is stored in a text file format.

(8) Cancellation processing is processing in which, during execution of the data storage processing, cancellation is performed to invalidate the data editing processing and a state at a time of the data display processing is acquired again.

(9) Error tag output processing is processing in which, during execution of the data storage processing, mandatory input check is performed for a screen item that can be input or corrected by the data editing processing, and when there is a blank item, an error message is displayed, the data is not stored, and a data editing screen is kept as it is.

A Nippon automated cargo and port consolidated system (NACCS) is a “comprehensive logistics information platform system” being managed by Nippon automated cargo and port consolidated system, Inc. (NACCS center). Data generated by the customs duty calculation system are transmitted to the NACCS.

While the example embodiments of the present invention is described above with reference to the drawings, those are merely examples of the present invention, and various configurations other than those described above may be adopted.

Note that, in the present specification, “acquisition” includes at least one of “an action of acquiring data stored in another apparatus or a storage medium by an own apparatus (active acquisition)”, based on a user input, or based on an instruction of a program, which includes, for example, an action of requesting or querying another apparatus for reception, an action of accessing another apparatus or a storage medium for retrieval, and the like, “an action of inputting data being output from another apparatus to an own apparatus (passive acquisition)”, based on a user input, or based on an instruction of a program, which includes, for example, an action of receiving data being distributed (or transmitted, push notified, or the like), or an action of selecting and acquiring from data or information being received, and “an action of generating new data by editing data (text conversion, data rearrangement, extraction of partial data, changes in file formats, and the like) or the like, and acquiring the generated new data”.

The whole or some of the example embodiments described above can be described as, but not limited to, the following supplementary notes.

1. An information processing apparatus, including:
an acquisition unit that acquires invoice information including a plurality of pieces of purchase data including at least cargo identification information and quantity information, and packing list information including a plurality of pieces of packing data including at least the cargo identification information and the quantity information: and
a generation unit that determines a correlation between the purchase data included in the invoice information and the packing data included in the packing list information by using a combination of the cargo identification information and the quantity information, and generates output information with which the purchase data and the packing data that are associated with each other are associated.

2. The information processing apparatus according to supplementary note 1, wherein
the purchase data do not include weight information, and the packing data include the weight information, and
the output information is information acquired by adding, to the invoice information, the weight information included in the packing list information.

3. The information processing apparatus according to supplementary note 1 or 2, wherein
when there is a piece of non-matching packing data being the piece of packing data in which a combination of the cargo identification information and the quantity information does not match with any piece of the purchase data, the generation unit generates collective data by collecting the piece of non-matching packing data, and generates the output information being associated with any piece of non-matching purchase data being the piece of purchase data in which a combination of the cargo identification information and the quantity information does not match with any piece of the packing data.

4. The information processing apparatus according to supplementary note 3, wherein
the purchase data do not include weight information, and the packing data include the weight information, and
the generation unit computes, as the collective data, a total value of the weight information in the non-matching packing data, and generates the output information in which the total value is associated with any piece of the non-matching purchase data.

5. The information processing apparatus according to supplementary note 3 or 4, wherein
the collective data is generated for each set of the pieces of non-matching packing data including the cargo identification information being identical, and the output information in which the collective data for the each set is associated with any piece of the non-matching purchase data including the cargo identification information being identical to the cargo identification information in the each set is generated.

6. The information processing apparatus according to any one of supplementary notes 1 to 5, wherein
the acquisition unit acquires the invoice information and the packing list information that are generated by using a character recognition function.

7. An information processing method including,
by a computer to execute:
an acquisition step of acquiring invoice information including a plurality of pieces of purchase data including at least cargo identification information and quantity information, and packing list information including a plurality of pieces of packing data including at least the cargo identification information and the quantity information; and
a generation step of determining a correlation between the purchase data included in the invoice information and the packing data included in the packing list information by using a combination of the cargo identification information and the quantity information, and generating output information with which the purchase data and the packing data that are associated with each other are associated.

8. A program causing a computer to function as:
an acquisition unit that acquires invoice information including a plurality of pieces of purchase data including at least cargo identification information and quantity information, and packing list information including a plurality of pieces of packing data including at least the cargo identification information and the quantity information; and
a generation unit that determines a correlation between the purchase data included in the invoice information and the packing data included in the packing list information by using a combination of the cargo identification information and the quantity information, and generates output information with which the purchase data and the packing data that are associated with each other are associated.

### REFERENCE SIGNS LIST

10 Information processing apparatus
11 Acquisition unit
12 Generation unit
13 Storage unit
1A Processor
2A Memory
3A Input/output I/F
4A Peripheral circuit
5A Bus

What is claimed is:

1. An information processing apparatus, comprising:
at least one memory configured to store one or more instructions; and
at least one processor configured to execute the one or more instructions to:
acquire invoice information including a plurality of pieces of purchase data including at least cargo identification information and quantity information, and packing list information including a plurality of pieces of packing data including at least the cargo identification information and the quantity information; and
determine a correlation between the purchase data included in the invoice information and the packing data included in the packing list information by using a combination of the cargo identification information and the quantity information, and generate output information with which the purchase data and the packing data that are associated with each other are associated.

2. The information processing apparatus according to claim 1, wherein
the purchase data do not include weight information, and the packing data include the weight information, and
the output information is information acquired by adding, to the invoice information, the weight information included in the packing list information.

3. The information processing apparatus according to claim 1, wherein the processor is further configured to execute the one or more instructions to
when there is a piece of non-matching packing data being the piece of packing data in which a combination of the cargo identification information and the quantity information does not match with any piece of the purchase data, generate collective data by collecting the piece of non-matching packing data, and generate the output information being associated with any piece of non-matching purchase data being the piece of purchase data in which a combination of the cargo identification information and the quantity information does not match with any piece of the packing data.

4. The information processing apparatus according to claim 3, wherein
the purchase data do not include weight information, and the packing data include the weight information, and
the processor is further configured to execute the one or more instructions to compute, as the collective data, a total value of the weight information in the non-matching packing data, and generates the output information in which the total value is associated with any piece of the non-matching purchase data.

5. The information processing apparatus according to claim 3, wherein
the collective data is generated for each set of the pieces of non-matching packing data including the cargo identification information being identical, and the output information in which the collective data for the each set is associated with any piece of the non-matching purchase data including the cargo identification information being identical to the cargo identification information in the each set is generated.

6. The information processing apparatus according to claim 1, wherein
the processor is further configured to execute the one or more instructions to acquire the invoice information and the packing list information that are generated by using a character recognition function.

7. An information processing method including,
by a computer to execute:
acquiring invoice information including a plurality of pieces of purchase data including at least cargo identification information and quantity information, and packing list information including a plurality of pieces of packing data including at least the cargo identification information and the quantity information; and
determining a correlation between the purchase data included in the invoice information and the packing data included in the packing list information by using a combination of the cargo identification information and the quantity information, and generating output information with which the purchase data and the packing data that are associated with each other are associated.

8. A non-transitory storage medium storing a program causing a computer to function as:
acquires acquire invoice information including a plurality of pieces of purchase data including at least cargo identification information and quantity information, and packing list information including a plurality of pieces of packing data including at least the cargo identification information and the quantity information; and
determine a correlation between the purchase data included in the invoice information and the packing data included in the packing list information by using a combination of the cargo identification information and the quantity information, and generate output information with which the purchase data and the packing data that are associated with each other are associated.
